(19) United States
(12) Patent Application Publication
(10) Pub. No.: US 2019/0219275 A1
(43) Pub. Date: Jul. 18, 2019

(54) Flushing Bypass System

(71) Applicant: Gordon CALLAWAY, Southampton (GB)

(72) Inventor: Gordon CALLAWAY, Southampton (GB)

(21) Appl. No.: 16/327,061

(22) PCT Filed: Aug. 21, 2017
(86) PCT No.: PCT/GB2017/052465

§ 371 Date: Feb. 21, 2019

(30) Foreign Application Priority Data
Aug. 24, 2016 (GB) 1614457.8
Nov. 30, 2016 (GB) 1620285.5

(51) Int. Cl. F24D 10/00; E03B 7/07; F24D 19/08; F16L 41/00; F24D 19/00

(52) U.S. Cl. CPC F24D 10/006; E03B 7/07; B01D 35/28; F16L 41/00; F24D 19/0092; F24D 19/082

(57) ABSTRACT

A flushing bypass system, particularly for use in a district or communal heating system, has a primary circuit 2 capable of supplying heat to a secondary circuit 10, the secondary circuit normally supplying heating through radiators 11 and/or hot water from tank 14 for occupants. The primary circuit has a furcated strainer 3 upstream from at least one heat exchanger and a limb of the furcated strainer is connected to a heat exchanger bypass assembly. The bypass assembly comprises a valve 21, which may be a timer valve, a manual valve or a smart valve, having an input 20 connected to the furcated strainer and an output 24 connected back into the primary circuit downstream of the heat exchanger. When the valve 21 is closed fluid passes through the furcated strainer to the heat exchanger and when the valve is open, fluid bypasses the heat exchanger and flushes contaminants from the furcated strainer back to the primary circuit downstream of the heat exchanger.

This invention relates to a flushing bypass system and particularly, although not exclusively, to a system for use in a district or communal heating system.

District or communal heating is, increasingly, becoming the preferred option for providing heating and hot water in new developments in the UK and across Europe. It is current policy that all new developments over a certain size in London and many other European cities must obtain their heat supply from a district or communal heating system. Modern installations and retrofits to existing district or communal heating schemes may employ a heat interface unit (HIU) with a heat exchanger to provide hydraulic separation between the district or communal heating water (herein referred to as the primary circuit) and the water within a dwelling or commercial unit (herein referred to as the secondary circuit) which usually contains radiators and may contain a hot water cylinder. This separation between the primary and secondary heating circuits is known as an ‘indirect’ system. All HIUs in indirect systems include one or more heat exchangers that transfer heat from the primary circuit into the secondary circuit. The HIU heat exchangers consist of many small water ways that can become readily blocked and so, are protected by an in-line furcated strainer which collects any debris in the primary water and prevents it from reaching and blocking the heat exchangers which would result in a loss of heat supply and the need to replace the expensive heat exchanger. However, if the strainer becomes blocked it will also prevent heat reaching the heat exchanger. Therefore, the strainer needs to be clean in order to allow hot water to flow into the heat exchanger and heat to pass from the primary system to the secondary system. It will be understood that if the flow of primary water is reduced it will result in a reduced heat supply. Accordingly, it is normally expected that a service engineer will be required to clean the strainers once a year as part of a planned servicing programme. If the primary water quality is maintained properly, an annual clean is usually sufficient to maintain a good flow and a reliable heat supply.

The foregoing applies to an indirect heating system. In a direct heating system there is no hydraulic separation between the primary and the secondary circuits. In a direct system water that flows through radiators and hot water cylinders in the secondary circuit is the same as the water that flows in the primary circuit. Such direct heating systems usually have a strainer installed at an interface between the primary and secondary circuits to prevent debris from entering the radiators and heat exchange coils within hot water tank. It will, again, be understood that any debris that collects in the strainer within a direct heating system will reduce the flow of water into the secondary system and result in a reduced heat supply.

It is to be understood that radiators and hot water tanks (cylinders) are, in themselves, heat exchangers and, as well as the heat exchanger with the HIU, are included in the term “heat exchanger” used herein.

The problem is that, other than sending a service engineer to manually clean the strainer, there is currently no alternative way to remove debris from the primary water or to restore the heat supply. In addition, it is common for the primary water to become very contaminated with debris and when this happens it blocks the in-line strainer more frequently than anticipated, limiting or obstructing the flow completely. In a badly affected system an engineer would be needed to visit and clean the strainer more than the planned once a year, adding to the planned servicing costs—in extreme cases a visit will be required on a daily basis until such time as steps are taken to remove the debris from the primary system. Even if the primary system is flushed, the strainer continues to act as a barrier to prevent any further debris that remains or develops upstream of it from passing through the HIU and being returned to the plant room where it can be removed with a filtration system.

The number of service engineer visits needed to clean the strainer depends on the extent of contamination and the time taken to remove the debris from the primary circuit and this varies from scheme to scheme. However, as mentioned above, once contaminated it is very difficult to remove the debris from the primary water and the contamination may have to be sustained for long periods, during which engineer visits to unblock the strainers are needed on a regular basis. This can become very expensive and the loss of heat supply for space heating and hot water can result in significant disruption to occupants as well as exposing landlords to significant service engineer costs and compensation payments for the loss of heat supply.

The average cost of an engineer visit is £100-150. Therefore, depending on the extent of contamination, (and the number of visits needed to unblock strainers), a solution that removes debris and restores heat automatically could save many thousands of pounds.

As the nature of district or communal heating is to supply heat and hot water to multiple dwellings and commercial units, when the primary water becomes contaminated it can affect everyone connected to the system. This can be anything from 20 up to 1000s of units, but most district and communal heating schemes are between 50 and 250 units.

The government's policy to install district and communal heating in the UK is relatively recent, i.e. the last 10 years. In most instances the contamination occurs in the early years of a newly installed system and it is thought that this could be because many of the landlords who find themselves owning and operating them are not experienced heat suppliers and do not become aware of the consequences of failing to maintain the primary water quality until it is too late. The debris generally manifests itself as a combination of granular limescale deposits (like the inside of a kettle), corrosion and very fine silt-like sludge. In a badly affected system flushing the primary circuit will not remove all of it as limescale and corrosion have a tendency to adhere to the inside of pipework and, in time, to fall away into the flow as the pipes expand and contract. Therefore, once contaminated, the problem is likely to last for many years.

Contamination of primary water is being experienced on a growing number of district and communal schemes and is forecast to continue growing until such time as those responsible for operating them become aware of the implications of failing to maintain water quality and start to focus on maintaining water quality from the start of a scheme.

The number of units connected to recently installed district or communal heating systems in the UK is probably in the region of 30,000. This will continue to increase as older schemes retrofit HIUs and more new developments are constructed and is expected to be in excess of 100,000 in the UK by 2030. There is a far greater number of district and communal heating schemes throughout Europe that may also be experiencing similar issues.

Although embodiments described herein relate to heating systems, it is to be understood the invention is not limited to heating systems and can be used on applications where there is a requirement to flush debris and contaminants from a furcated strainer to a location downstream of equipment being protected by said furcated strainer whether the strainer is a newly installed strainer, a pre-existing strainer, or an additional strainer.

The present invention seeks to at least partially mitigate the foregoing problems.

According to this invention in its broadest aspect, there is provided a flushing bypass system for a fluid system including equipment that needs protecting from debris and contaminants in the fluid, said equipment being protected by a furcated strainer upstream of said equipment, said furcated strainer being connected to a bypass assembly comprising valve means having input and output connector means, said input connector means being arranged to be connected to said furcated strainer and said output connector means being arranged to be connected downstream of the said equipment, whereby when the valve means is closed fluid passes through the furcated strainer to the equipment, and when the valve means is open, fluid bypasses said equipment and flushes contaminants from the furcated strainer downstream of said equipment.

Preferably the furcated strainer is one of a strainer newly installed upstream of said equipment, a strainer pre-existing upstream of said equipment, and an additional furcated strainer provided either upstream or downstream of a pre-existing furcated strainer upstream of said equipment.

According to a feature of this invention there is provided a flushing bypass system for use in a district or communal heating system including a primary circuit and a secondary circuit, said secondary circuit including at least one heat exchanger supplying heating and/or hot water for occupants, said primary circuit having a furcated strainer upstream of said secondary circuit, said furcated strainer being connected to a bypass assembly comprising valve means having input and output connector means, said input connector means being arranged to be connected to said furcated strainer and said output connector means being arranged to be connected downstream of the said at least one heat exchanger, whereby when the valve means is closed fluid passes through the furcated strainer to the at least one heat exchanger, and when the valve means is open, fluid bypasses the at least one heat exchanger and flushes contaminants from the furcated strainer to the primary circuit downstream of the at least one heat exchanger.

Preferably the furcated strainer is one of a newly installed strainer in the primary circuit of said system, a strainer pre-existing in the primary circuit of said system, and an additional furcated strainer provided in the primary circuit either upstream or downstream of a pre-existing furcated strainer in the primary circuit.

Preferably, the input connector means of said valve means is a flushing nipple connected to the furcated strainer.

Conveniently, the output connector means is a pipe and a T-piece connecting the pipe from the downstream side of the valve means to the T-piece in the primary circuit.

Advantageously, the valve means is arranged to be opened at periods of low occupant heat requirement, for example at night.

Conveniently, the valve means is arranged to be opened two to three times a day for periods of five to ten minutes each.

Preferably, the valve means is one of a timer valve, a manually operable valve, and a smart valve operable from a remote source such as a telephone.

Advantageously, where the valve means is a smart valve, said smart valve includes a receiver for receiving signals from the remote source and in dependence thereon is arranged to open or close a fluidic valve.

Preferably, the heating system is one of an indirect and a direct heating system.

In some embodiments, the furcated strainer may be a strainer pre-existing in the primary circuit of said system, or said assembly may also include an additional furcated strainer arranged to be provided in the primary circuit either upstream or downstream of a pre-existing furcated strainer in the primary circuit.

Due to the relatively new adoption of HIUs in district or communal heating schemes, the problem has not been appropriately addressed. Those experiencing contamination have been more focussed on employing engineers to clean strainers and to remove the debris from the primary water than on looking into ways to prevent the problem. In addition, those employed to clean the strainers do so in an ad-hoc manner and are not in possession of the whole picture. Currently, it is the housing sector that is most affected by the problem of blockage and the problem is not being viewed systematically.

The present invention thus provides a means of removing debris and contaminants from district or communal heating systems employing indirect or direct heating systems in order to provide a solution that a failure to maintain water quality so that occupants do not lose their heat supply.

The invention, when a timer or smart valve is used, also removes the need for a service engineer to make a visit to restore the heat supply when contamination occurs.

Although the invention has particular relevance to heating systems, it is believed that the invention has broader significance in that it may be used in fluid systems where equipment is protected by a strainer upstream of the equipment and by bypassing the equipment, the strainer may be cleansed by flushing the fluid and any debris and contaminants to a point downstream of the equipment. For example, the present system may be applied to cooling pipes where it is required to protect coils and heat exchangers, or on fuel lines, or milk processing plant, or any fluid process where there is fluid passing through pipes in equipment that needs protecting from debris and contaminants in the fluid by providing a flushable strainer upstream of the equipment.

It will be understood that the present invention may not only be used for individual apartments, but may be used further upstream in a plant room, e.g. in communal heating plant rooms where Y strainers are employed to protect the heat exchangers from debris and contaminants. In such a communal system, such Y strainers may be automatically flushed and any debris and contaminants returned to the main system filter by employing the present invention.

The invention will now be described, by way of example, with reference to the accompanying drawings in which:

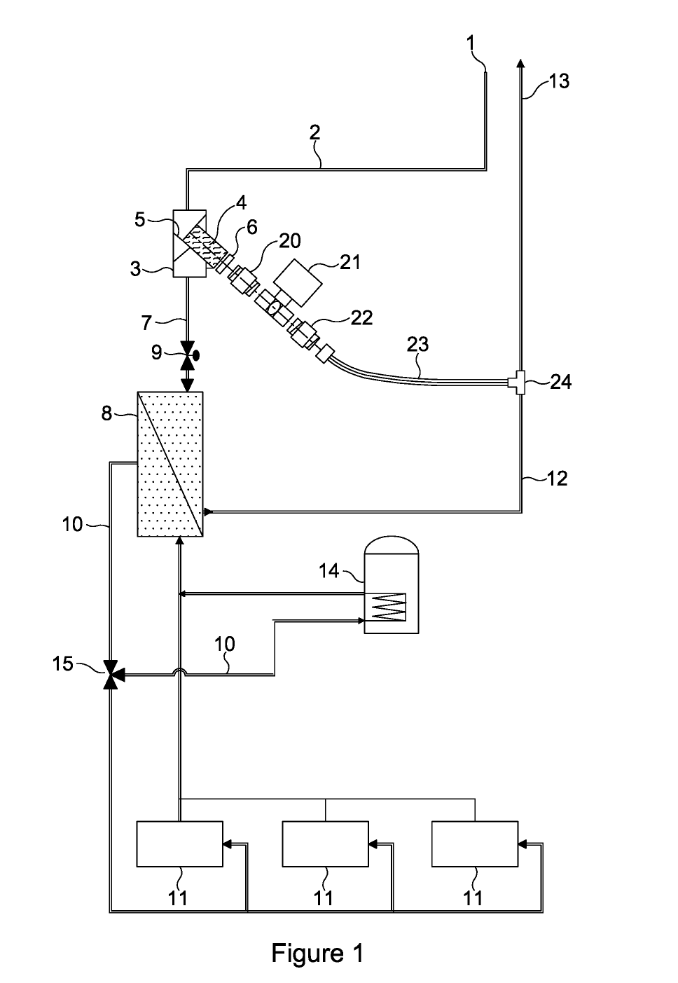

FIG. 1 shows, in schematic form, a heating system of an indirect type in accordance with this invention, and

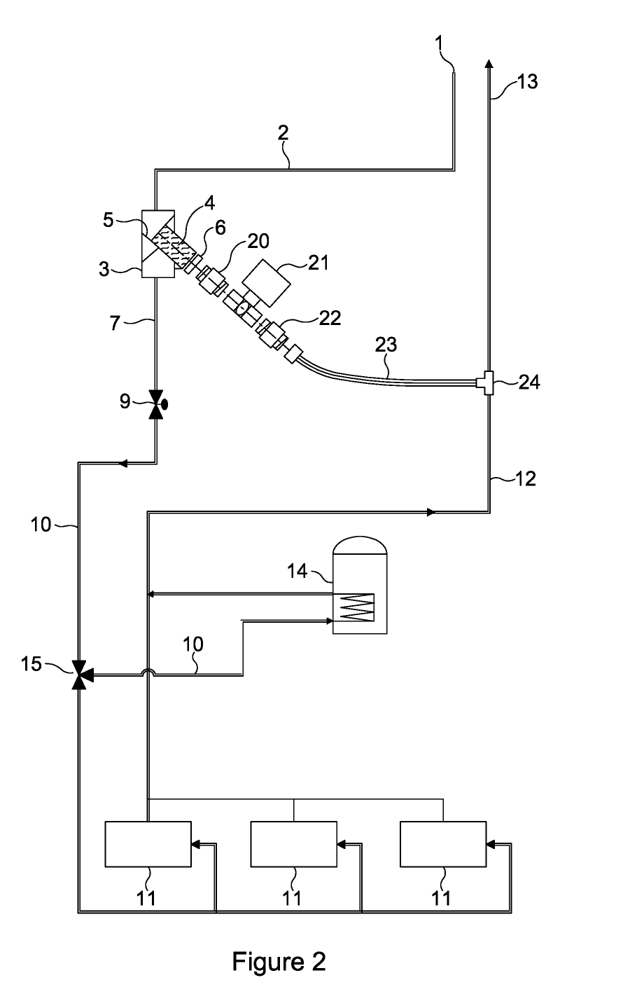

FIG. 2 shows in schematic form, a heating system of a direct type in accordance with this invention.

In the Figures like reference numerals denote like parts.

Referring to FIG. 1, a district or communal heating system of the indirect type is shown in the drawing in which a heat interface unit (HIU) has a water flow input 1 to a primary circuit 2. Fluid, normally water, in the primary circuit flows into a furcated strainer 3, which may be, for example, a strainer made by Tacotherm Limited, in which there is a strainer filter 4 in a limb of the strainer which abuts a constricting portion 5. In a known, currently used system, the strainer 3 has an external portion 6 which is closed by a blanking plug. Water flowing past the constricting portion 5 through the filter of the strainer 4 passes through a pipe 7 via a valve 9 operable by a timer/programmer (not shown) to a heat exchanger 8 of the HIU, for example made by Alfa Laval, where heat within the primary water system is exchanged to a secondary circuit 10 that feeds customer radiators 11, only three being shown by way of example, and a hot water tank (cylinder) 14. The valve 9 is normally controlled by an occupant via a programmer. The programmer may be set to provide heat and/or hot water by setting on/off times using a timer facility on the programmer, or switching on and off manually.

In the exemplary embodiment, a valve 15 is provided between the heat exchanger 8 and the radiators. The valve 15 is a three-port valve used to divert water in the secondary system to the radiators 11 or to the hot water tank 14. The valve 15 is, preferably, controlled by a timer/programmer (not shown) to supply water from the secondary circuit, in one position thereof, to a heating coil within a hot water tank (cylinder) 14, and in another position thereof to the radiators 11. Output from the radiators and the heating coil is fed back into the heat exchanger 8. Water in the primary system flows through the heat exchanger 8 and back into a primary system pipe 12 where it exits at outlet 13. Heat flow through the primary and secondary circuits is indicated by arrow headed lines.

The present invention provides the additional serial components of a flushing nipple 20 that is connected into the strainer 3 in place of the blanking plug, the flushing nipple 20 being connected to, in one preferred embodiment, a timer valve 21, which, for example may be Tofine Group Company Limited model TCM30P, a fluid connector 22, and a pipe 23 to a T-piece 24 interconnecting with the primary circuit in pipe 12. Where it is not practical to connect to an already existing furcated strainer an additional furcated strainer may be added in place of, or in addition to, the existing furcated strainer and the additional furcated strainer may be located either upstream or downstream of the pre-existing furcated strainer.

The timer valve 21 acts as a plug when the valve 21 is closed enabling the mesh to catch any debris in the primary water circuit so that it may fulfil its primary function of protecting the heat exchanger 8. The timer valve 21 preferably, has an electronic timer that may be set to open a number of times a day for a period determined by a user. Tests have shown that the best cleaning results are achieved by setting the timer valve 21 to open a minimum of two to three times a day for a period of five to ten minutes each to maximise the opportunity for removing debris from the mesh. Such action also prevents debris from consolidating on the inside of the mesh which may reduce the effectiveness of the automatic flushing process. The operation of the timer valve 21 may be set to occur at times of low or no heat demand to avoid occupants being affected by the periods when flushing is taking place, since during that period there will be no heat provided to the radiators 11 or hot water tank 14.

When the flushing timer valve 21 opens it allows primary water to flush through the strainer filter 4 at system pressure which is normally between two and ten bar, thereby removing any debris from the mesh of the filter and allows the water to pass back into the primary circuit downstream of the flushing timer valve 21 and heat exchanger 8.

When the timer valve 21 closes, the system returns to its normal function and the flow of heat is restored because the mesh of the filter 4 has been cleaned. In a badly affected system where the filter mesh becomes blocked every day, the fact that it is cleaned every day will enable occupants to have continual heat, except during the flushing process. The pipe 23 and T-piece 24 downstream of the flushing timer valve 21 act to bypass and protect the heat exchanger, and return any contaminated water back to the primary circuit 2 downstream of the heat exchanger 8. It will be understood that debris bypasses the heat exchanger 8 and flows freely back to a plant room (not shown) receiving water from outlet 13 where the debris may be collected in a master strainer or, in some circumstances, returned to the primary circuit 2. However, this latter operation is not recommended, since it is inadvisable to allow debris to enter the primary circuit.

The heating system shown in FIG. 2 is a direct system in which the heat exchanger 8 is omitted with fluid flow from the primary circuit 2 passing via the strainer 3 and valve 9 to the secondary circuit 10.

Thus, when timer valve 21 is closed and valve 9 is open, fluid passes into the secondary circuit 10 and, in dependence upon the position of valve 15, as determined by the programmer/timer (not shown), fluid passes into the radiators 11 and/or the heating coil of tank 14, thence back into the primary circuit. When timer valve 21 is open fluid flushes through the strainer filter 4 to clean the filter and the fluid bypasses the secondary circuit 10.

A major benefit of the present invention is that it provides a landlord with the ability to automatically flush debris back to the plant room where it can be caught by a master strainer. Thus, over time, an already contaminated system will clean itself and so the present invention has great advantage as a retro-fit kit.

From the foregoing it will be understood that the present invention is an automatic bypass assembly which automatically flushes debris from a furcated strainer, bypassing and protecting heat exchangers 8, 11 and 14 and restoring a heat supply to an occupant via radiators 11 and hot water via tank 14. The present invention does not require manual intervention and operates by connecting the furcated strainer to a flushing nipple which, in turn, is connected to a flushing timer valve 21 that is set to clean the strainer for a pre-set period, or a number of pre-set periods, each day at a time which will not cause disruption to occupants. Debris that is flushed from the strainer bypasses the heat exchanger and is returned to the primary circuit downstream of the heat exchanger from whence it may be returned to a plant room.

It will be understood that the flushing bypass assembly of the present invention automatically removes debris from the primary circuit and restores heat supply to an occupant by maximising the flow rate through the heat exchangers. In a blocked strainer the flow rate may be reduced to zero as the strainer becomes increasingly blocked. The flow rate in a domestic system normally needs to be above five hundred litres/hour in order to allow heat to be transferred to the secondary circuit at a rate that is fast enough to enable the occupants to obtain hot water and space heating. Thus, flow rate is critical. By restoring the flow rate using this invention, occupants are able to enjoy heating and hot water. By providing an automatic flushing system, occupants and landlords are saved the cost of calling out an engineer. Further, a clean strainer reduces the amount of time that occupants have to wait for hot water and heating by maximising the flow rate through the heat exchanger, thereby improving the efficiency of the heat supply and providing improved functionality of the heating system. The improved efficiency results in reduced heat costs because occupants do not need to run their system for longer than necessary to obtain the heat required.

The cost of manually flushing an entire primary circuit is generally between £10,000-£85,000 depending on the size of scheme and number of blocks/rises that need flushing and this cost is substantially avoided by the present invention.

It is anticipated that the present invention will be used in newly installed systems and will have great benefit as a retro-fit kit in existing heating systems.

In an alternative embodiment, instead of using timer valve 21, a manually operable valve may be utilised which may be operated on a regular basis or when a problem is found by a user.

In yet another embodiment, a smart valve having a receiver for receiving signals over the ether may be utilised, the receiver operating the valve when signalled to do so. The signals may be transmitted from a remote source, such as a telephone that may be connected to a landline, or a cellular phone. Again, in such an embodiment the smart valve would be a fluidic valve operable at times determined by a user.

It will be understood that the present invention is not limited to use in a heating system and may be employed where equipment needs to be protected from debris and contaminants by a strainer located upstream of the equipment, such as cooling pipes where it is desired to protect coils and heat exchangers, or on fuel lines, or milk processing plant, or any fluid process where fluid passes through pipes and equipment that needs protecting from debris and contaminants in the fluid by a strainer located upstream of the equipment. In this respect, the invention provides a flushing bypass assembly whereby the strainer is cleansed by flushing the contaminants to a point downstream of the equipment.

1: A flushing bypass system for a fluid system including equipment (11, 14) that needs protecting from debris and contaminants in the fluid, said fluid system including a furcated strainer (3), characterized in that said bifurcated strainer (3) is located in a flow path upstream to said equipment, said furcated strainer being connected to a bypass assembly comprising valve means (21) having input (20) and output (22, 24) connector means, said input connector means being arranged to be connected to said furcated strainer and said output connector means (22, 24) being arranged to be connected downstream of the said equipment (11, 14), whereby when the valve means (21) is closed fluid passes through the furcated strainer (3) to the equipment (11, 14), and when the valve means (21) is open, fluid bypasses said equipment (11, 14) and flushes contaminants from the furcated strainer (3) downstream of said equipment (11, 14).

2: A flushing bypass system for use in a district or communal heating system including a primary circuit (2) and a secondary circuit (10), said secondary circuit (10) including at least one heat exchanger (8, 11, 14) supplying heating and/or hot water for occupants, said primary circuit having a furcated strainer (3) in a flow path upstream to said secondary circuit (10), characterized by said furcated strainer (3) being connected to a bypass assembly comprising valve means (21) having input (20) and output (22, 24) connector means, said input connector means being arranged to be connected to said furcated strainer and said output connector means being arranged to be connected downstream of the said at least one heat exchanger (8, 11, 14), whereby when the valve means is closed fluid passes through the furcated strainer to the at least one heat exchanger, and when the valve means is open, fluid bypasses the at least one heat exchanger and flushes contaminants from the furcated strainer to the primary circuit downstream of the at least one heat exchanger.

3: A system as claimed in claim 2, wherein the furcated strainer (3) is one of a strainer newly installed in the primary circuit of said system, a strainer pre-existing in the primary circuit of said system, and an additional furcated strainer provided in the primary circuit either upstream or downstream of a pre-existing furcated strainer in the primary circuit.

4: A system as claimed in claim 1, wherein the input connector means (20) of said valve means (21) is a flushing nipple connected to the furcated strainer (3).

5: A system as claimed in claim 2, wherein the output connector means is a pipe (23) and a T-piece (24) connecting the pipe from the downstream side of the valve means to the T-piece in the primary circuit (2).

6: A system as claimed in claim 1, wherein the valve means (21) is arranged to be opened at periods of low occupant heat requirement, for example at night.

7: A system as claimed in claim 2, wherein the valve means (21) is arranged to be opened at periods of low occupant heat requirement, for example at night.

8: A system as claimed in claim 1, wherein the valve means (21) is one of a timer valve, a manually operable valve, and a smart valve operable from a remote source such as a telephone.

9: A system as claimed in claim 8, wherein where the valve means (21) is a smart valve, said smart valve includes a receiver for receiving signals from the remote source and in dependence thereon is arranged to open or close a fluidic valve.

10: A system as claimed in claim 2, wherein the heating system is one of an indirect and a direct heating system.

11: A system as claimed in claim 1, wherein the furcated strainer (3) is one of a strainer newly installed upstream of said equipment, a strainer pre-existing upstream of said equipment, and an additional furcated strainer provided either upstream or downstream of a pre-existing furcated strainer upstream of said equipment.

12: A system as claimed in claim 2, wherein the input connector means (20) of said valve means (21) is a flushing nipple connected to the furcated strainer (3).

13: A system as claimed in claim 3, wherein the input connector means (20) of said valve means (21) is a flushing nipple connected to the furcated strainer (3).

14: A system as claimed in claim 3, wherein the valve means (21) is arranged to be opened at periods of low occupant heat requirement, for example at night.

15: A system as claimed in claim 4, wherein the valve means (21) is arranged to be opened at periods of low occupant heat requirement, for example at night.

16: A system as claimed in claim 5, wherein the valve means (21) is arranged to be opened at periods of low occupant heat requirement, for example at night.

17: A system as claimed in claim 12, wherein the valve means (21) is arranged to be opened at periods of low occupant heat requirement, for example at night.

18: A system as claimed in claim 13, wherein the valve means (21) is arranged to be opened at periods of low occupant heat requirement, for example at night.

19: A system as claimed in claim 2, wherein the valve means (21) is one of a timer valve, a manually operable valve, and a smart valve operable from a remote source such as a telephone.

20: A system as claimed in claim 19, wherein where the valve means (21) is a smart valve, said smart valve includes a receiver for receiving signals from the remote source and in dependence thereon is arranged to open or close a fluidic valve.
